(19) United States
(12) Patent Application Publication
(10) Pub. No.: US 2006/0105159 A1
(43) Pub. Date: May 18, 2006

(54) Gas diffusion medium with microporous bilayer

(76) Inventors: Jeanette E. O'Hara, Honeoye, NY (US); Hubert A. Gasteiger, Rochester, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/987,131

(22) Filed: Nov. 12, 2004

(51) Int. Cl. B32B 3/26

(52) U.S. Cl. 428/318.6; 428/317.9

(57) ABSTRACT

A gas diffusion medium with microporoous bilayer is disclosed. The gas diffusion medium includes a diffusion medium substrate, with a dual layer, including a first sublayer that is comprised of a variation in particle sizes and second layer composed of one material with a uniform particle size. The gas diffusion medium with microporous bilayer has enhanced cushioning and water management properties.

### FIELD OF THE INVENTION

The present invention relates to fuel cells which generate electricity to power vehicles or other electrically driven devices. More particularly, the present invention relates to a novel gas diffusion medium having a microporous bilayer which includes a sublayer and a MPL (microporous layer) coating on the sublayer to enhance cushioning and water management capabilities of the gas diffusion media.

### BACKGROUND OF THE INVENTION

Fuel cell technology is a relatively recent development in the automotive industry. It has been found that fuel cell power plants are capable of achieving efficiencies as high as 55%. Furthermore, fuel cell power plants emit only heat and water as by-products.

Fuel cells include three components: a cathode, an anode and a polymer electrolyte which is sandwiched between the cathode and the anode and conducts protons. Catalyst layers disposed on both sides of the membrane serve as electrodes. In operation, the catalyst on the anode splits hydrogen into electrons and protons. The electrons are distributed as electric current from the anode, through a drive motor and then to the cathode, whereas the protons migrate from the anode, through the electrolyte to the cathode. The catalyst on the cathode combines the protons with electrons returning from the drive motor and oxygen from the air to form water. Individual fuel cells can be stacked together in series to generate increasingly larger quantities of electricity.

In a Polymer-Electrolyte-Membrane (PEM) fuel cell, a perfluorosulfonic acid (PFSA) membrane serves as the electrolyte between a cathode and an anode; other types of proton conducting membranes have also been evaluated and are used in few instances. The polymer membrane currently being used in fuel cell applications requires a certain level of humidity to facilitate conductivity of the membrane. Therefore, maintaining the proper level of humidity in the membrane, through humidity/water management, is very important for the proper functioning of the fuel cell. Irreversible damage to the fuel cell may occur if the membrane dries out.

In order to prevent leakage of the hydrogen fuel gas and oxygen gas supplied to the electrodes and prevent mixing of the gases, a gas-sealing material and gaskets are arranged on the periphery of the electrodes, with the polymer electrolyte membrane sandwiched there between. The sealing material and gaskets may be assembled into a single part together with the electrodes and polymer electrolyte membrane to form a membrane electrode assembly (MEA). Disposed outside of the MEA are conductive separator plates (also known as bipolar plates) for mechanically securing the MEA and electrically connecting adjacent MEAs in series. A portion of the separator plate, disposed toward the MEA, is provided with a gas passage or flow field for supplying hydrogen and air to the electrode surfaces and removing generated water.

In the fuel cell, a gas diffusion medium which is typically made from nonwoven carbon fiber paper or woven carbon cloth is interposed between the flow field of the bipolar plate and the MEA. Gas diffusion media play several important roles in a PEM fuel cell. Primarily, gas diffusion media serve as a conduit for the diffusion of reactant hydrogen and air gas streams to the anode and cathode, respectively, as well as a conduit for the removal of by-product water from the cathode. In addition, gas diffusion media must be sufficiently electrically conductive to pass electrons to the bipolar plate.

Recently, the importance of a microporous layer (MPL) disposed between the electrode and the gas diffusion medium (GDM) has been noted. This microporous layer primarily enhances the water management capabilities of a PEM fuel cell, thereby decreasing mass transport losses that are caused by poor GDM structure. Typically, this layer is a polytetrafluoroethylene/carbon mixture and has variable thickness depending on the particular properties desired for the GDM. Another important function of the microporous layer is protection of the membrane from being penetrated by the brittle carbon fibers in the GDM substrate, thus preventing electrical shorting.

It has been found that forming the MPL as a bilayer structure both enhances the cushioning property of the MPL and water management capabilities of the fuel cell. The size of pores in the MPL generally increase in the z direction from the electrode to the GDM. According to the present invention, a sublayer is provided on a GDM and a MPL coating is provided on the sublayer. The sublayer has a novel packing structure and pore size distribution which reduces puncturing of the MEA by carbon fibers while also enhancing water management of the cell. The sublayer is made up of electrically conductive particles (preferably graphite or other carbon blacks) and a binder (preferably PTFE or other perfluorinated and partially fluorinated polymers). The average pore-size of the sublayer is determined by the average aggregate size of the conductive particles in the sublayer. The average aggregate size of conductive particles in the sublayer may range from 0.1 to 0.3 micrometer (corresponding to the average particle aggregate size in the MPL) up to ca. 20 to 40 micrometer. The conductive particles in the sublayer may be composed of two different particle size ranges, for example of a mixture of carbon blacks with an average primary aggregate size of 0.1 to 0.3 micrometer and graphite particles with an average particle size of 1 to 10 micrometer. The preferred range of the average particle aggregate size of the larger particles in the in the sublayer, however, is 0.5 to 30 micrometer, with a most preferred range of 1 to 10 micrometer. The desired puncture resistance and cushioning effect of the sublayer in general increases with increasing thickness. Therefore, the thickness of the sublayer may range from 10 to 100 micrometer, with a preferred thickness ranging from 30 to 60 micrometer.

### SUMMARY OF THE INVENTION

The present invention is generally directed to a gas diffusion medium which includes a GDM (gas diffusion medium) substrate having a microporous bilayer provided on the substrate. The gas diffusion medium with microporous bilayer exhibits enhanced cushioning and water management properties in a fuel cell. The microporous bilayer includes a sublayer which is provided on the GDM substrate and a microporous layer (MPL) coating provided on the sublayer. The sublayer is a composite material having graphite powder, carbon powder and a fluorinated polymer and has a novel packing structure and pore size distribution due to the wide range of particles sizes present in the layer. The MPL coating traditionally includes carbon blacks with average primary aggregate sizes of 0.1 to 0.3 micrometer and a fluorinated polymer such as polytetrafluoroethylene. The sublayer may consist of conductive particles (e.g., graphite) with an average particle size ranging from 0.1 to 40 micrometer; a preferred particle size range, however is 0.5 to 30 micrometer, or, most preferably 1 to 10 micrometer. In all cases, it is preferred that the particle size distribution of the graphite powder (or other conductive particles) is reasonably narrow and mono-modal. To achieve optimum cushioning and puncture protection properties of the sublayer, its thickness may range from 10 to 100 micrometer, and preferably from 30 to 60 micrometer. Besides the large conductive particles in the sublayer described above (i.e., up to 40 micrometer), carbon blacks or other conductive particles with average aggregate sizes ranging from 0.1 to 1 micrometer or, preferably from 0.1 to 0.3 micrometer may also be mixed into the sublayer. Therefore, the sublayer may consist of two or more different kinds of conductive particles which have distinctively different average particle sizes and a perfluorinated or partially fluorinated polymeric binder.

### BRIEF DESCRIPTION OF THE DRAWINGS

The invention will now be described, by way of example, with reference to the accompanying drawings, in which:

FIG. 1 is a cross-sectional view of a gas diffusion medium with microporous bilayer of the present invention;

FIG. 2 is a schematic view of a fuel cell stack having a gas diffusion medium with microporous bilayer of the present invention on the cathode side and anode side, respectively, of a membrane electrode assembly (MEA); and

FIG. 3 is a flow diagram which illustrates sequential process steps carried out according to a typical method of fabricating a gas diffusion medium with microporous bilayer of the present invention.

### DETAILED DESCRIPTION OF THE INVENTION

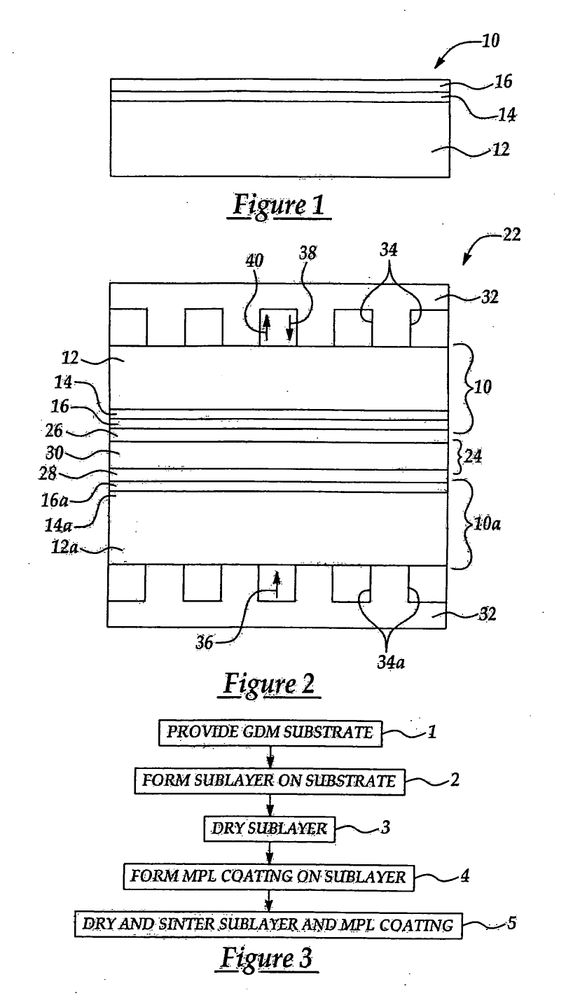

Referring initially to FIG. 1, an illustrative embodiment of the gas diffusion medium with microporous bilayer, hereinafter gas diffusion medium, is generally indicated by reference numeral 10. The gas diffusion medium 10 includes a GDM (gas diffusion medium) substrate 12 which may be a conventional fuel cell gas diffusion material such as nonwoven carbon fiber paper or woven carbon cloth, for example. An example of a material which is suitable for the GDM substrate 12 is the Toray 060 substrate available from the Toray Corp., New York, N.Y. Alternative materials which are suitable for use as the GDM substrate 12 include carbon paper or cloth substrates which are available from Spectracorp and SGL, for example.

A sublayer 14 is provided on the GDM substrate 12, and a MPL coating 16 is provided on the sublayer 14. The sublayer 14 is a composite material which includes a mixture of graphite powder (or other conductive particles), carbon blacks and a fluorinated polymer (e.g., polytetrafluoroethylene) or other partially fluorinated polymers (e.g., PVDF). Preferably, the graphite powder particles in the sublayer 14 have a mean particle size ranging from 0.1 to 40 micrometer, with a preferred range of 0.5 to 30 micrometer, and a most preferred range of 1 to 10 micrometer. It is preferred that the particle size distribution of the graphite powder is reasonably narrow and mono-modal. Carbon blacks which may or may not be added to the sublayer have an average primary aggregate size of 0.1 to 1 micrometer or, preferably 0.1 to 0.3 micrometer (similar to the carbon particles or carbon blacks used in the MPL). Consequently, the sublayer 14 has a novel packing structure, and thus, a novel pore size distribution which allows the formation of relatively thick sublayers without compromising its water management properties. The thickness of the sublayer ranges from 10 to 100 micrometer, and preferably from 30 to 60 micrometer. These characteristics of the sublayer 14, in combination with the MPL coating 16, enhance the cushioning function and the water management capability of the GDM substrate 12 in a fuel cell.

Referring next to FIG. 2, a fuel cell stack 22 in implementation of the bi-layered gas diffusion medium 10 of the present invention is shown. The fuel cell stack 22 includes a membrane electrode assembly (MEA) 24 having a polymer electrolyte membrane (PEM) 30 which is sandwiched between a cathode 26 and an anode 28. A bipolar plate 32 on the cathode side of the MEA 24 includes multiple flow channels 34, and a bipolar plate 32a on the anode side of the MEA 24 includes multiple flow field channels 34a.

During operation of the fuel cell 22, hydrogen gas flows through the flow field channels 34a of the bipolar plate 32a and diffuses through the gas diffusion medium 10a to the anode 28. In like manner, oxygen or air flows through the flow field channels 34 of the bipolar plate 32 and diffuses through the gas diffusion medium 10 to the cathode 26. The bi-layered microporous structure which includes the MPL coating 16, 16a and underlying sublayer 14, 14a, respectively, facilitates enhanced cushioning of the MEA 24 with respect to the gas diffusion media 10, specifically with respect to the carbon fibers used GDM substrates 12/12a, and enhances the water management capability of the fuel cell 22.

The flow diagram of FIG. 3 illustrates sequential process steps carried out in typical fabrication of the gas diffusion medium with microporous bilayer according to the present invention. In step 1, a gas diffusion medium (GDM) substrate is provided. The GDM substrate may be a conventional carbon fiber paper or cloth material, for example, which is suitable for use as a gas diffusion medium in a fuel cell, such as a Toray 060 substrate available from the Toray Corp., New York, N.Y.

In step 2, a sublayer is formed on the substrate. The sublayer is a composite material which includes a mixture of graphite powder (or other electrically conductive particles), carbon blacks (or other carbon powders conventionally used in, for example, MPL formulations) and a fluorinated polymer such as polytetrafluoroethylene or partially fluorinated polymers such as PVDF. A graphite powder which is suitable for formation of the sublayer is M490 graphite powder available from Asbury Graphite Mills, Inc., for example. The graphite powder may have a particle size somewhere in between 0.1 and 40 micrometer. Preferably, the graphite powder has a particle size of between about 0.5 μm and 30 μm. Most preferably, the graphite powder has a mean particle size of about 1 to 10 μm. In all cases, it is preferred that the particle size distribution is reasonably narrow and mono-modal. Other suitable graphite powders include artificial graphite powders having a particle size of between about >1 μm and <20 μm, and most preferably, a mean particle size between 1 um and 10 μm.

A carbon powder which is suitable for formation of the sublayer includes acetylene black carbon powder available from Alfa Aesar, for example. Suitable alternatives for the carbon powder include most carbon blacks, including Vulcan XC-72 and Black Pearls 2000. The polytetrafluoroethylene may be provided in the form of a T-30 solution, for example, which is available from the Dupont corp. and includes 60 wt. % PTFE. Other fluorinated polymer that would be suitable include HFP, PVDF, and FEP.

The sublayer may be formed on the substrate by initially shearing the graphite powder and carbon powder in a water and isopropyl alcohol solution. This is followed by addition of the T-30 solution. The resulting sublayer mixture is then shaken manually for about 1-2 minutes. The sublayer mixture is coated onto the GDM substrate typically using a Meyer rod, but may be coated by other means, such as knife coating, gravure coating, screen printing, etc. In step 3 of FIG. 3, the sublayer is dried on the GDM substrate.

In step 4, an MPL (microporous layer) coating is formed on the sublayer. The MPL coating may be conventional and is a composite material which includes carbon powder (typically carbon blacks) and a fluorinated or partially fluorinated polymer. A carbon powder which is suitable for formation of the sublayer includes acetylene black carbon powder available from Alfa Aesar, for example. Suitable alternatives for the carbon powder include most carbon blacks, including Vulcan XC-72 and Black Pearls 2000, for example. The polytetrafluoroethylene may be provided in the form of a T-30 solution, for example, which is available from the Dupont Corporation. Other chemical substances to control, for example, the pH of the mixture may be added.

The MPL coating may be formed on the sublayer by initially shearing the carbon powder in deionized water and isopropyl alcohol. This is followed by addition of the T-30 solution. The resulting MPL coating mixture is then shaken manually for about 1-2 minutes. The MPL coating mixture is coated onto the GDM substrate typically using a Meyer rod, and then air-dried. In step 5 of FIG. 3, the resulting GDM substrate with microporous bilayer is dried and sintered at 380 degrees C. for 20 minutes.

Fabrication of the GDM substrate with microporous bilayer according to the present invention will be further understood by reference to the following examples.

### EXAMPLE I

### Formation of Sublayer

A sublayer was formed on a Toray 060 substrate by initially obtaining 1.2 g of Acetylene Black carbon (Alfa Aesar, 100% compressed, surface area 70 m²/g), 1.2 g of M490 graphite powder (Asbury Graphite Mill) with particle sizes of >1 μm and <20 μm, 1.33 g of T-30 solution (Dupont, 60 wt. % PTFE), 25 mL IPA (isopropyl alcohol), and 15 mL of deionized water. The Acetylene Black carbon particles and graphite powder were sheared at 14500 rpm for 10 minutes in the deionized water and isopropyl alcohol. The T-30 solution was added to the sheared black carbon powder and graphite powder, which was shaken by hand for 1-2 minutes to form a sublayer mixture. The sublayer mixture was then coated on the Toray 060 substrate using a Meyer rod and then dried.

### Formation of MPL Coating

An MPL coating was formed on the sublayer prepared according to Example (I) above by initially obtaining 2.4 g of Acetylene Black carbon (Alfa Aesar, 100% compressed, surface area 70 m²/g), 1.33 g of T-30 solution (Dupont, 60 wt. % PTFE), 32 mL IPA, 37 mL of deionized water. The Acetylene black carbon and graphite powder were sheared at 14500 rpm for 10 minutes. The T-30 solution was then added to the sheared carbon black, which were shaken by hand for 1-2 minutes to form an MPL coating mixture. The MPL coating mixture was then coated on the sublayer using a Meyer rod and then dried. The resulting GDM substrate with microporous bilayer was then dried and sintered at 380 degrees C. for 20 minutes.

Water management capabilities of the GDM substrate with microporous bilayer of the present invention have been observed by testing a 50 cm² PEM fuel cell and observing water management capabilities under exaggerated conditions. The cushioning capability of the invention has been observed by running a pressure-to-short test in which a membrane is sandwiched between two GDM substrates with microporous bilayer. The MEA is compressed until an electrical short is measured. Cushioning effects were observed as greater resistance at higher loads as compared to less desirable samples.

While the preferred embodiments of the invention have been described above, it will be recognized and understood that various modifications can be made in the invention and the appended claims are intended to cover all such modifications which may fall within the spirit and scope of the invention.

What is claimed is:

1. A gas diffusion medium comprising:
a diffusion medium substrate;
a sublayer; and
a microporous layer coating provided on said sublayer.

2. The gas diffusion medium of claim 1 wherein said sublayer comprises conductive particles and an at least partially fluorinated polymer.

3. The gas diffusion medium of claim 2 wherein said conductive particles comprises particles having an average particle size ranging from about 0.1 to about 40 micrometer.

4. The gas diffusion medium of claim 2 wherein said sublayer has a thickness of from about 10 to about 100 micrometer.

5. The gas diffusion medium of claim 1 wherein said microporous layer coating comprises carbon black particles and an at least partially fluorinated polymer.

6. The gas diffusion medium of claim 5 further comprising pH-adjusting chemicals in said microporous layer coating.

7. The gas diffusion medium of claim 5 wherein said sublayer comprises black carbon, graphite powder having a particle size of between about 1 μm and about 20 μm and polytetrafluoroethylene.

8. The gas diffusion medium of claim 7 wherein said graphite particles have a mean particle size between 1 um and 10 μm.

9. A gas diffusion medium comprising:
a diffusion medium substrate;
a sublayer comprising graphite on said substrate; and
a microporous layer coating substantially devoid of graphite provided on said sublayer.

10. The gas diffusion medium of claim 9 wherein said sublayer further comprises black carbon and polytetrafluoroethylene.

11. The gas diffusion medium of claim 10 wherein said graphite comprises graphite particles having a particle size of between about 1 μm and about 20 μm.

12. The gas diffusion medium of claim 11 wherein said graphite particles have a mean particle size between 1 and 10 μm.

13. The gas diffusion medium of claim 9 wherein said microporous layer coating comprises black carbon, polytetrafluoroethylene and a pH adjusting compound.

14. The gas diffusion medium of claim 13 wherein said pH-adjusting compound comprises ammonium carbonate.

15. The gas diffusion medium of claim 13 wherein said graphite comprises graphite particles having a particle size of between about 1 μm and about 20 μm.

16. The gas diffusion medium of claim 15 wherein said graphite particles have a mean particle size between 1 um and 10 μm.

17. A method of fabricating a gas diffusion medium, comprising:
providing a diffusion medium substrate;
providing a sublayer comprising graphite said substrate; and
providing a microporous layer coating on said sublayer.

18. The method of claim 17 wherein said graphite has a particle size of between about 1 μm and about 20 μm.

19. The method of claim 18 wherein said graphite has a mean particle size between 1 um and 10 μm.

20. The method of claim 19 wherein said microporous layer coating comprises black carbon, polytetrafluoroethylene and a pH-adjusting compound.
